(19) United States
(12) Patent Application Publication
(10) Pub. No.: US 2011/0310870 A1
(43) Pub. Date: Dec. 22, 2011

(54) HYBRID TIME AND FREQUENCY DOMAIN CSI FEEDBACK SCHEME

(75) Inventors: Didier Johannes Richard Van Nee, De Meern (NL); Hemanth Sampath, San Diego, CA (US); Sameer Vermani, San Diego, CA (US); Rahul Tandra, San Diego, CA (US); Albert Van Zelst, Woerden (NL); Vincent Knowles Jones, IV, Redwood City, CA (US)

(73) Assignee: QUALCOMM INCORPORATED, San Diego, CA (US)

(21) Appl. No.: 13/164,514

(22) Filed: Jun. 20, 2011

Related U.S. Application Data
(60) Provisional application No. 61/356,989, filed on Jun. 21, 2010.
(60) Provisional application No. 61/372,796, filed on Aug. 11, 2010.

(51) Int. Cl. H04L 27/06; H04W 4/00; H04L 27/00

(52) U.S. Cl. 370/338; 375/295; 375/316; 375/340; 375/341

(57) ABSTRACT

In a downlink multi-user multiple input multiple output (DL MU-MIMO) system, channel state information (CSI) feedback duration may strongly affect media access control (MAC) efficiency. While a time domain compression may give a significant reduction in feedback duration, the time domain compression may have complexity issues at the station (STA). In particular, for time domain compression, a large complex matrix multiplication may be required at the client to estimate a cyclic prefix (CP) length impulse response, which best models the frequency response of the channel. Embodiments of the invention comprise a hybrid scheme that may reduce the above complexity while maintaining significant compression gains.

### CROSS-REFERENCE TO RELATED APPLICATION

This application claims priority to U.S. Provisional Application Ser. Nos. 61/356,989, filed on Jun. 21, 2010, and 61/372,796, filed on Aug. 11, 2010, which are expressly incorporated by reference herein in its entirety.

### BACKGROUND

1. Field

Certain aspects of the present disclosure generally relate to wireless communications and, more particularly, to a method for reducing channel state information (CSI) feedback duration.

2. Background

In order to address the issue of increasing bandwidth requirements that are demanded for wireless communication systems, different schemes are being developed to allow multiple user terminals to communicate with a single access point (AP) by sharing the channel resources while achieving high data throughputs. Multiple input multiple output (MIMO) technology represents one such approach that has recently emerged as a popular technique for the next generation communication systems. MIMO technology has been adopted in several emerging wireless communications standards such as the Institute of Electrical and Electronics Engineers (IEEE) 802.11 standard. The IEEE 802.11 denotes a set of wireless local area network (WLAN) air interface standards developed by the IEEE 802.11 committee for short-range communications (e.g., tens of meters to a few hundred meters).

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

In wireless networks with a single AP and multiple user stations (STAs), concurrent transmissions may occur on multiple channels toward different STAs, both in uplink and downlink directions. Many challenges are present in such systems. For example, the AP may transmit signals using different standards such as the IEEE 802.11n/a/b/g or the IEEE 802.11ac standards. A receiver STA may be able to detect a transmission mode of the signal based on information included in a preamble of the transmission packet.

A downlink multi-user MIMO (MU-MIMO) system based on spatial division multiple access (SDMA) transmission can simultaneously serve a plurality of spatially separated STAs by applying beamforming at the AP's antenna array. Complex transmit precoding weights can be calculated by the AP based on channel state information (CSI) received from each of the supported STAs.

Since a channel between the AP and a STA of the plurality STAs may vary with time due to a mobility of that STA or due to mode stirring caused by objects moving in the STA's environment, the CSI may need to be updated periodically in order for the AP to accurately beamform to that particular STA. A required rate of CSI feedback for each STA may depend on a coherence time of a channel between the AP and that STA. An insufficient feedback rate may adversely impact performance due to inaccurate beamforming. On the other hand, an excessive feedback rate may produce minimal additional benefit, while wasting valuable medium time.

In a scenario consisting of multiple spatially separated users, it is expected that the channel coherence time, and therefore the appropriate CSI feedback rate, varies spatially across the users. In addition, due to various factors, such as changing channel conditions and mobility of a user, the appropriate CSI feedback rate may also vary temporally for each of the users. For example, some STAs (such as a high definition television (HDTV) or set-top box) may be stationary, whereas others (such as handheld devices) may be subject to motion. Furthermore, a subset of STAs may be subject to a high Doppler from fluorescent light effects. Finally, multi-paths to some STAs may have more Doppler than others since different scatterers may move at different velocities and affect different subsets of STAs.

Therefore, if a single rate of CSI feedback is utilized for all supported STAs in a wireless system, the system performance may suffer due to inaccurate beamforming for those STAs with insufficient feedback rates, and/or due to excessive feedback overhead for those STAs with unnecessarily high feedback rates.

In conventional schemes, the CSI feedback occurs at a rate consistent with the worst-case user in terms of mobility or temporal channel variation. For an SDMA system consisting of STAs experiencing a range of channel conditions, no single CSI feedback rate is appropriate for all STAs. Catering to the worst-case user may result in an unnecessary waste of channel resources by forcing STAs in relatively static channel conditions to feedback CSI at the same rate as those in a highly dynamic channel.

For example, in the case of an evolution-data optimized (EV-DO) data rate control channel (DRC), the “channel state” information reflects a received pilot signal-to-interference-plus-noise ratio (SINR) and is transmitted by a STA to facilitate rate selection for the next transmission. This information is updated at a fixed rate for all users, presumably at a rate sufficient to track channel variations associated with the worst-case expected mobility situations. This rate of channel state feedback may be unnecessarily high for static users. In this case, however, the DRC was designed to provide minimal overhead. Because the CSI in an SDMA system is used to support complex beamforming at the AP, it may not be feasible to compress or streamline this feedback to the degree accomplished in the EV-DO design.

As another example, for the Institute of Electrical and Electronic Engineers (IEEE) 802.11n standard supporting transmit beamforming, the rate at which CSI is transmitted is not specified, and this is considered an implementation issue. In contrast, due to the potentially high overhead of CSI feedback for multiple SDMA users in the IEEE 802.11ac standard, and due to potential abuse of such CSI feedback mechanism by rogue STAs, it may be desirable to specify protocols for CSI feedback in the standard specification.

### SUMMARY

Certain aspects of the present disclosure provide a method for wireless communications. The method generally includes estimating a multiple input multiple output (MIMO) channel used to receive transmissions from an access point (AP), generating a truncated channel impulse response for the estimated channel, generating frequency domain feedback for a subset of tones of the estimated channel, and transmitting channel state information (CSI) feedback to the AP, the CSI feedback comprising the truncated channel impulse response and the frequency domain feedback.

Certain aspects provide an apparatus for wireless communication. The apparatus generally includes logic for estimating a multiple input multiple output (MIMO) channel used to receive transmissions from an access point (AP), logic for generating a truncated channel impulse response for the estimated channel, logic for generating frequency domain feedback for a subset of tones of the estimated channel, and logic for transmitting channel state information (CSI) feedback to the AP, the CSI feedback comprising the truncated channel impulse response and the frequency domain feedback.

Certain aspects provide an apparatus for wireless communication. The apparatus generally includes means for estimating a multiple input multiple output (MIMO) channel used to receive transmissions from an access point (AP), means for generating a truncated channel impulse response for the estimated channel, means for generating frequency domain feedback for a subset of tones of the estimated channel, and means for transmitting channel state information (CSI) feedback to the AP, the CSI feedback comprising the truncated channel impulse response and the frequency domain feedback.

Certain aspects provide a computer-program product for wireless communication, comprising a computer-readable medium having instructions stored thereon, the instructions being executable by one or more processors. The instructions generally include instructions for estimating a multiple input multiple output (MIMO) channel used to receive transmissions from an access point (AP), instructions for generating a truncated channel impulse response for the estimated channel, instructions for generating frequency domain feedback for a subset of tones of the estimated channel, and instructions for transmitting channel state information (CSI) feedback to the AP, the CSI feedback comprising the truncated channel impulse response and the frequency domain feedback.

Certain aspects of the present disclosure provide a method for wireless communications. The method generally includes receiving channel state information (CSI) feedback from an access terminal (AT), the CSI feedback comprising a truncated channel impulse response for an estimated multiple input multiple output (MIMO) channel used to transmit transmissions to the AT and frequency domain feedback for a subset of tones of the estimated channel and reconstructing the estimated channel based on the CSI feedback.

Certain aspects provide an apparatus for wireless communication. The apparatus generally includes logic for receiving channel state information (CSI) feedback from an access terminal (AT), the CSI feedback comprising a truncated channel impulse response for an estimated multiple input multiple output (MIMO) channel used to transmit transmissions to the AT and frequency domain feedback for a subset of tones of the estimated channel and logic for reconstructing the estimated channel based on the CSI feedback.

Certain aspects provide an apparatus for wireless communication. The apparatus generally includes means for receiving channel state information (CSI) feedback from an access terminal (AT), the CSI feedback comprising a truncated channel impulse response for an estimated multiple input multiple output (MIMO) channel used to transmit transmissions to the AT and frequency domain feedback for a subset of tones of the estimated channel and means for reconstructing the estimated channel based on the CSI feedback.

Certain aspects provide a computer-program product for wireless communication, comprising a computer-readable medium having instructions stored thereon, the instructions being executable by one or more processors. The instructions generally include instructions for receiving channel state information (CSI) feedback from an access terminal (AT), the CSI feedback comprising a truncated channel impulse response for an estimated multiple input multiple output (MIMO) channel used to transmit transmissions to the AT and frequency domain feedback for a subset of tones of the estimated channel and instructions for reconstructing the estimated channel based on the CSI feedback.

Certain aspects of the present disclosure provide a method for transmitting channel state information (CSI) feedback in 802.11 wireless communications. The method generally includes estimating a first set of frequency domain channel coefficients from very high throughput long training fields (VHT-LTFs) transmitted from an access point (AP); generating a second set of frequency domain channel coefficients for a subset of tones; generating the CSI feedback by quantizing the first and second sets of frequency domain channel coefficients and including additional receiver information; and transmitting the CSI feedback to the AP.

Certain aspects provide an apparatus for transmitting channel state information (CSI) feedback in 802.11 wireless communications. The apparatus generally includes logic for estimating a first set of frequency domain channel coefficients from very high throughput long training fields (VHT-LTFs) transmitted from an access point (AP); logic for generating a second set of frequency domain channel coefficients for a subset of tones; logic for generating the CSI feedback by quantizing the first and second sets of frequency domain channel coefficients and including additional receiver information; and logic for transmitting the CSI feedback to the AP.

Certain aspects provide an apparatus for transmitting channel state information (CSI) feedback in 802.11 wireless communications. The apparatus generally includes means for estimating a first set of frequency domain channel coefficients from very high throughput long training fields (VHT-LTFs) transmitted from an access point (AP); means for generating a second set of frequency domain channel coefficients for a subset of tones; means for generating the CSI feedback by quantizing the first and second sets of frequency domain channel coefficients and including additional receiver information; and means for transmitting the CSI feedback to the AP.

Certain aspects provide a computer-program product for transmitting channel state information (CSI) feedback in 802.11 wireless communications, comprising a computer-readable medium having instructions stored thereon, the instructions being executable by one or more processors. The instructions generally include instructions for estimating a first set of frequency domain channel coefficients from very high throughput long training fields (VHT-LTFs) transmitted from an access point (AP); instructions for generating a second set of frequency domain channel coefficients for a subset of tones; instructions for generating the CSI feedback by quantizing the first and second sets of frequency domain channel coefficients and including additional receiver information; and instructions for transmitting the CSI feedback to the AP.

Certain aspects of the present disclosure provide a method for wireless communications. The method generally includes estimating a multiple input multiple output (MIMO) channel used to receive transmissions from an access point (AP); estimating a first set of frequency domain channel coefficients for the estimated channel from fields transmitted from the AP; generating a second set of frequency domain channel coefficients for a subset of tones of the estimated channel; generating channel state information (CSI) feedback by quantizing the first and second sets of frequency domain channel coefficients; and transmitting the CSI feedback to the AP.

Certain aspects provide an apparatus for wireless communications. The apparatus generally includes logic for estimating a multiple input multiple output (MIMO) channel used to receive transmissions from an access point (AP); logic for estimating a first set of frequency domain channel coefficients for the estimated channel from fields transmitted from the AP; logic for generating a second set of frequency domain channel coefficients for a subset of tones of the estimated channel; logic for generating channel state information (CSI) feedback by quantizing the first and second sets of frequency domain channel coefficients; and logic for transmitting the CSI feedback to the AP.

Certain aspects provide an apparatus for wireless communications. The apparatus generally includes means for estimating a multiple input multiple output (MIMO) channel used to receive transmissions from an access point (AP); means for estimating a first set of frequency domain channel coefficients for the estimated channel from fields transmitted from the AP; means for generating a second set of frequency domain channel coefficients for a subset of tones of the estimated channel; means for generating channel state information (CSI) feedback by quantizing the first and second sets of frequency domain channel coefficients; and means for transmitting the CSI feedback to the AP.

Certain aspects provide a computer-program product for wireless communications, comprising a computer-readable medium having instructions stored thereon, the instructions being executable by one or more processors. The instructions generally include instructions for estimating a multiple input multiple output (MIMO) channel used to receive transmissions from an access point (AP); instructions for estimating a first set of frequency domain channel coefficients for the estimated channel from fields transmitted from the AP; instructions for generating a second set of frequency domain channel coefficients for a subset of tones of the estimated channel; instructions for generating channel state information (CSI) feedback by quantizing the first and second sets of frequency domain channel coefficients; and instructions for transmitting the CSI feedback to the AP.

Certain aspects of the present disclosure provide a method for wireless communications. The method generally includes receiving channel state information (CSI) feedback from an access terminal (AT), the CSI feedback comprising receiver information, quantized values of a first set of frequency domain channel coefficients from very high throughput long training fields (VHT-LTFs) used to transmit transmissions to the AT, and quantized values of a second set of frequency domain channel coefficients for a subset of tones; and reconstructing an estimated multiple input multiple output (MIMO) channel based on the CSI feedback.

Certain aspects provide an apparatus for wireless communications. The apparatus generally includes logic for receiving channel state information (CSI) feedback from an access terminal (AT), the CSI feedback comprising receiver information, quantized values of a first set of frequency domain channel coefficients from very high throughput long training fields (VHT-LTFs) used to transmit transmissions to the AT, and quantized values of a second set of frequency domain channel coefficients for a subset of tones; and logic for reconstructing an estimated multiple input multiple output (MIMO) channel based on the CSI feedback.

Certain aspects provide an apparatus for wireless communications. The apparatus generally includes means for receiving channel state information (CSI) feedback from an access terminal (AT), the CSI feedback comprising receiver information, quantized values of a first set of frequency domain channel coefficients from very high throughput long training fields (VHT-LTFs) used to transmit transmissions to the AT, and quantized values of a second set of frequency domain channel coefficients for a subset of tones; and means for reconstructing an estimated multiple input multiple output (MIMO) channel based on the CSI feedback.

Certain aspects provide a computer-program product for wireless communications, comprising a computer-readable medium having instructions stored thereon, the instructions being executable by one or more processors. The instructions generally include instructions for receiving channel state information (CSI) feedback from an access terminal (AT), the CSI feedback comprising receiver information, quantized values of a first set of frequency domain channel coefficients from very high throughput long training fields (VHT-LTFs) used to transmit transmissions to the AT, and quantized values of a second set of frequency domain channel coefficients for a subset of tones; and instructions for reconstructing an estimated multiple input multiple output (MIMO) channel based on the CSI feedback.

Certain aspects of the present disclosure provide a method for wireless communications. The method generally includes receiving channel state information (CSI) feedback from an access terminal (AT), the CSI feedback comprising a first set of frequency domain channel coefficients for an estimated multiple input multiple output (MIMO) channel used to transmit transmissions to the AT and a second set frequency domain channel coefficients for a subset of tones of the estimated channel; and reconstructing the estimated channel based on the CSI feedback.

Certain aspects provide an apparatus for wireless communications. The apparatus generally includes logic for receiving channel state information (CSI) feedback from an access terminal (AT), the CSI feedback comprising a first set of frequency domain channel coefficients for an estimated multiple input multiple output (MIMO) channel used to transmit transmissions to the AT and a second set frequency domain channel coefficients for a subset of tones of the estimated channel; and logic for reconstructing the estimated channel based on the CSI feedback.

Certain aspects provide an apparatus for wireless communications. The apparatus generally includes means for receiving channel state information (CSI) feedback from an access terminal (AT), the CSI feedback comprising a first set of frequency domain channel coefficients for an estimated multiple input multiple output (MIMO) channel used to transmit transmissions to the AT and a second set frequency domain channel coefficients for a subset of tones of the estimated channel; and means for reconstructing the estimated channel based on the CSI feedback.

Certain aspects provide a computer-program product for wireless communications, comprising a computer-readable medium having instructions stored thereon, the instructions being executable by one or more processors. The instructions generally include instructions for receiving channel state information (CSI) feedback from an access terminal (AT), the CSI feedback comprising a first set of frequency domain channel coefficients for an estimated multiple input multiple output (MIMO) channel used to transmit transmissions to the AT and a second set frequency domain channel coefficients for a subset of tones of the estimated channel; and instructions for reconstructing the estimated channel based on the CSI feedback.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a wireless communications network, in accordance with certain aspects of the present disclosure.

FIG. 2 illustrates a block diagram of an example access point and user terminals, in accordance with certain aspects of the present disclosure.

FIG. 3 illustrates a block diagram of an example wireless device, in accordance with certain aspects of the present disclosure.

FIG. 4 illustrates an example system with an access point and an access terminal, capable of performing a hybrid time and frequency domain channel state information (CSI) feedback scheme, in accordance with certain aspects of the present disclosure.

FIG. 5 illustrates example operations for transmitting CSI feedback to an access point (AP), in accordance with certain aspects of the present disclosure.

FIG. 6 illustrates example operations for receiving CSI feedback from an access terminal (AT), in accordance with certain aspects of the present disclosure.

FIG. 7 illustrates a sequential CSI feedback scheme, in accordance with certain aspects of the present disclosure.

FIG. 8 illustrates a table of performance specifications comparing the CSI feedback duration for various options, in accordance with certain aspects of the present disclosure.

FIG. 9 illustrates example operations for transmitting a unified feedback format CSI feedback to an AP, in accordance with certain aspects of the present disclosure.

FIG. 10 illustrates example operations for receiving a unified feedback format CSI feedback from an AT, in accordance with certain aspects of the present disclosure.

### DETAILED DESCRIPTION

In a downlink multi-user multiple input multiple output (DL MU-MIMO) system, channel state information (CSI) feedback duration may strongly affect media access control (MAC) efficiency. While a time domain compression may give a significant reduction in feedback duration, the time domain compression may have complexity issues at the station (STA). In particular, for time domain compression, a large complex matrix multiplication may be required at the client to estimate a cyclic prefix (CP) length impulse response, which best models the frequency response of the channel. Embodiments of the invention comprise a hybrid scheme that may reduce the above complexity while maintaining significant compression gains.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various broadband wireless communication systems, including communication systems that are based on a single carrier transmission. Aspects disclosed herein may be, for example, advantageous to systems employing ultra wide band (UWB) signals including millimeter-wave signals. However, the present disclosure is not intended to be limited to such systems, as other coded signals may benefit from similar advantages.

An access point (“AP”) may comprise, be implemented as, or known as NodeB, radio network controller (“RNC”), eNodeB, base station controller (“BSC”), base transceiver station (“BTS”), base station (“BS”), transceiver function (“TF”), radio router, radio transceiver, basic service set (“BSS”), extended service set (“ESS”), radio base station (“RBS”), or some other terminology.

An access terminal (“AT”) may comprise, be implemented as, or known as an access terminal, a subscriber station, a subscriber unit, a mobile terminal, a remote station, a remote terminal, a user terminal, a user agent, a user device, user equipment, a user station, or some other terminology. In some implementations, an access terminal may comprise a cellular telephone, a cordless telephone, a session initiation protocol (“SIP”) phone, a wireless local loop (“WLL”) station, a personal digital assistant (“PDA”), a handheld device having wireless connection capability, a station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

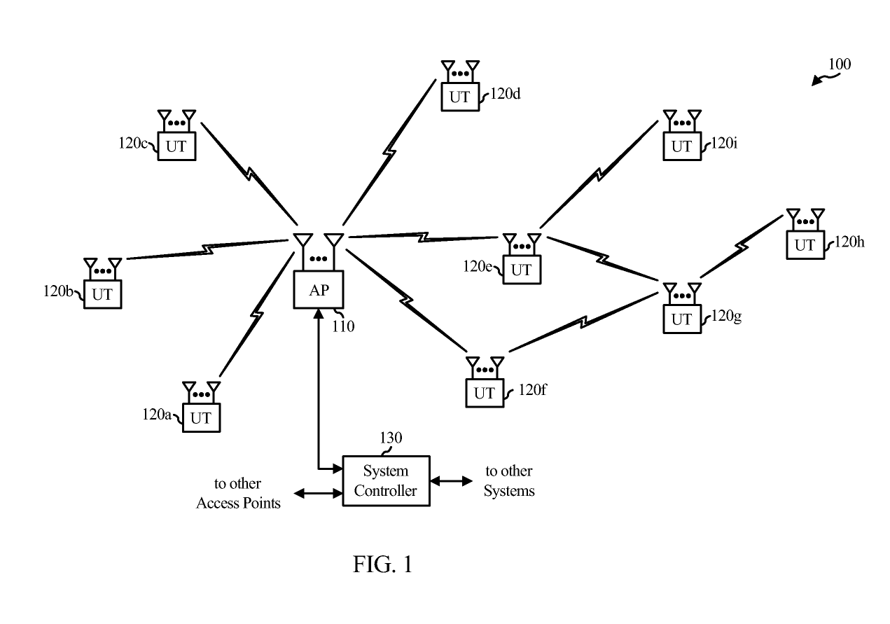

FIG. 1 illustrates a multiple-access MIMO system 100 with access points and user terminals, in which the procedures described for a hybrid time and frequency domain CSI feedback scheme may be performed. For simplicity, only one access point 110 is shown in FIG. 1. An access point (AP) is generally a fixed station that communicates with the user terminals and may also be referred to as a base station or some other terminology. A user terminal may be fixed or mobile and may also be referred to as a mobile station, a station (STA), a client, a wireless device, or some other terminology. A user terminal may be a wireless device, such as a cellular phone, a personal digital assistant (PDA), a handheld device, a wireless modem, a laptop computer, a personal computer, etc.

Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal A system controller 130 couples to and provides coordination and control for the access points.

System 100 employs multiple transmit and multiple receive antennas for data transmission on the downlink and uplink. Access point 110 is equipped with a number Nₐₚ of antennas and represents the multiple-input (MI) for downlink transmissions and the multiple-output (MO) for uplink transmissions. A set Nᵤ of selected user terminals 120 collectively represents the multiple-output for downlink transmissions and the multiple-input for uplink transmissions. In certain cases, it may be desirable to have Nₐₚ≧Nᵤ≧1 if the data symbol streams for the Nᵤ user terminals are not multiplexed in code, frequency or time by some means. Nᵤ may be greater than Nₐₚ if the data symbol streams can be multiplexed using different code channels with CDMA, disjoint sets of sub-bands with OFDM, and so on. Each selected user terminal transmits user-specific data to and/or receives user-specific data from the access point. In general, each selected user terminal may be equipped with one or multiple antennas (i.e., Nᵤₜ≧1). The Nᵤ selected user terminals can have the same or different number of antennas.

MIMO system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). MIMO system 100 may represent a high speed wireless local area network (WLAN) operating in a 60 GHz band.

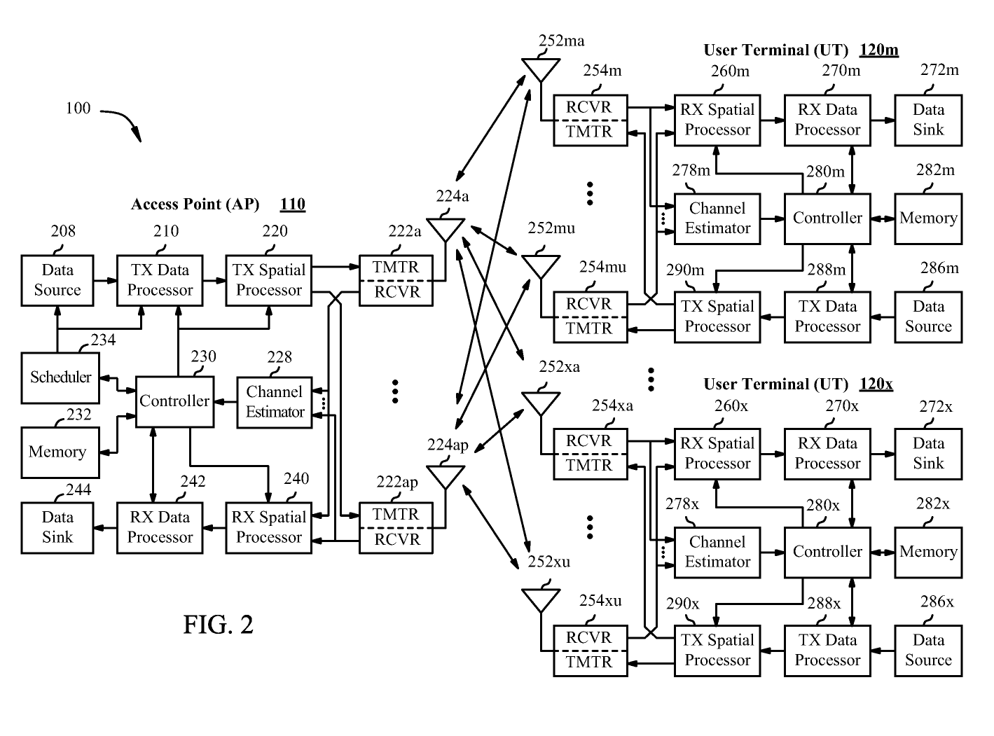

FIG. 2 shows a block diagram of access point 110 and two user terminals 120m and 120x in MIMO system 100. Access point 110 is equipped with Nₐₚ antennas 224a through 224ap. User terminal 120m is equipped with N_{ut,m} antennas 252ma through 252mu, and user terminal 120x is equipped with N_{ut,x} antennas 252xa through 252xu. Access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a frequency channel, and a “receiving entity” is an independently operated apparatus or device capable of receiving data via a frequency channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a TX data processor 288 receives traffic data from a data source 286 and control data from a controller 280. The controller 280 may be coupled with a memory 282. TX data processor 288 processes (e.g., encodes, interleaves, and modulates) the traffic data {d_{up,m}} for the user terminal based on the coding and modulation schemes associated with the rate selected for the user terminal and provides a data symbol stream {s_{up,m}}. A TX spatial processor 290 performs spatial processing on the data symbol stream {s_{up,m}} and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point 110.

A number Nᵤₚ of user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), successive interference cancellation (SIC), or some other technique. Each recovered uplink data symbol stream {s_{up,m}} is an estimate of a data symbol stream {s_{up,m}} transmitted by a respective user terminal. An RX data processor 242 processes (e.g., demodulates, deinterleaves, and decodes) each recovered uplink data symbol stream {s_{up,m}} in accordance with the rate used for that stream to obtain decoded data. The decoded data for each user terminal may be provided to a data sink 244 for storage and/or a controller 230 for further processing. The controller 230 may be coupled with a memory 232.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal TX data processor 210 provides N_{dn} downlink data symbol streams for the N_{dn} user terminals. A TX spatial processor 220 performs spatial processing on the N_{dn} downlink data symbol streams, and provides Nₐₚ transmit symbol streams for the Nₐₚ antennas. Each transmitter unit (TMTR) 222 receives and processes a respective transmit symbol stream to generate a downlink signal. Nₐₚ transmitter units 222 provide Nₐₚ downlink signals for transmission from Nₐₚ antennas 224 to the user terminals.

At each user terminal 120, N_{ut,m} antennas 252 receive the Nₐₚ downlink signals from access point 110. Each receiver unit (RCVR) 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream {s_{dn,m}} for the user terminal. The receiver spatial processing is performed in accordance with the channel correlation matrix inversion (CCMI), minimum mean square error (MMSE), or some other technique. An RX data processor 270 processes (e.g., demodulates, deinterleaves, and decodes) the recovered downlink data symbol stream to obtain decoded data for the user terminal. The decoded data for each user terminal may be provided to a data sink 272 for storage and/or a controller 280 for further processing.

At each user terminal 120, a channel estimator 278 estimates the downlink channel response and provides downlink channel estimates, which may include channel gain estimates, SNR estimates, noise variance and so on. Similarly, a channel estimator 228 estimates the uplink channel response and provides uplink channel estimates. Controller 280 for each user terminal typically derives the spatial filter matrix for the user terminal based on the downlink channel response matrix H_{dn,m} for that user terminal Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

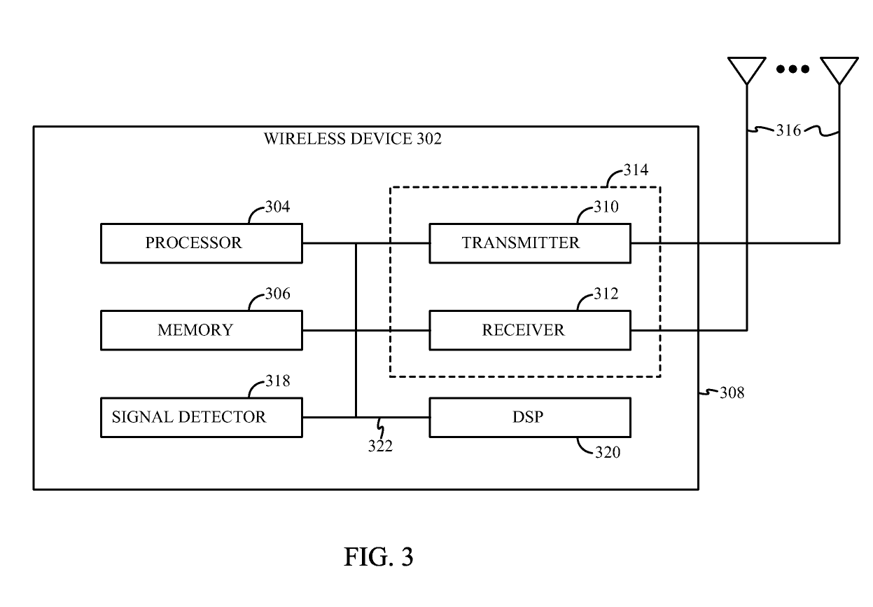

FIG. 3 illustrates various components that may be utilized in a wireless device 302 that may be employed within the system 100. The wireless device 302 is an example of a device that may be configured to implement the various methods described herein. The wireless device 302 may be an access point 110 or a user terminal 120.

The wireless device 302 may include a processor 304 that controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote location. The transmitter 310 and receiver 312 may be combined into a transceiver 314. A plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

### Hybrid Time and Frequency Domain CSI Feedback Scheme

In a downlink multi-user multiple input multiple output (DL MU-MIMO) system, channel state information (CSI) feedback duration may strongly affect media access control (MAC) efficiency. While a time domain compression may give a significant reduction in feedback duration, the time domain compression may have complexity issues at the station (STA). In particular, for time domain compression, a large complex matrix multiplication may be required at the client to estimate a cyclic prefix (CP) length impulse response, which best models the frequency response of the channel. Embodiments of the invention comprise a hybrid scheme that may reduce the above complexity while maintaining significant compression gains. The hybrid scheme comprises an inverse fast Fourier transform (IFFT) based time domain compression in conjunction with frequency domain feedback for some of the tones, where the reconstructed channel from the IFFT based time domain feedback alone may not be accurate.

For the Institute of Electrical and Electronic Engineers (IEEE) 802.11n standard, provisions for frequency domain CSI feedbacks comprise raw channel coefficients, uncompressed V matrix that may be based on a singular value decomposition of a channel, and compressed V matrix. The CSI feedback duration may strongly affect MAC efficiency for MU-MIMO. Time representation of the channel may be used to achieve compression gains. However, a large complex matrix multiplication at the client to estimate a CP length impulse response may be required, which best models the frequency response of the channel.

When the number of stations (STAs) in a network is small (e.g., less than or equal to four stations), the incentive for CSI compression may be minimal, as all transmissions may happen to a same group, wherein one group may comprise, for example, four STAs. Assuming a coherence time of 800 ms, just one occurrence of a null data packet (NDP) followed by CSI feedbacks every 20 ms may be required, wherein a feedback delay of 20 ms may imply a −25 dBc feedback error.

However, when the number of MU-MIMO capable STAs in a network is large, CSI feedback may result in a large overhead. All transmissions in a 20 ms period may happen to a non-overlapping set of STAs. As a result, CSI feedback may need to occur before every MU-MIMO transmission. For example, the last CSI feedback from a particular set of STAs may be old or inaccurate. Therefore, one occurrence of NDP followed by CSI feedbacks may be required every transmission opportunity (TxOP) (e.g., every 3 ms). For some embodiments, CSI compression may have strong benefits in this regime.

Traditionally, a time domain compression scheme may provide a compression over raw channel feedback by around a factor of four, wherein the time domain compression scheme may estimate a cyclic prefix (CP) length impulse response, which best models the frequency response. However, there may be complexity issues at the STA. In particular, for time domain compression, a large complex matrix multiplication may be required at the client to estimate the CP length impulse response. For example, for 40 MHz, a 32×114 complex matrix multiplication may be required at the STA, wherein separate multiplication may be required for each entry of the channel matrix.

For some embodiments, a hybrid scheme may reduce the above-mentioned complexity while maintaining significant compression gains. The hybrid scheme may involve providing an impulse response feedback and a frequency domain feedback for some of the tones, as will be described further.

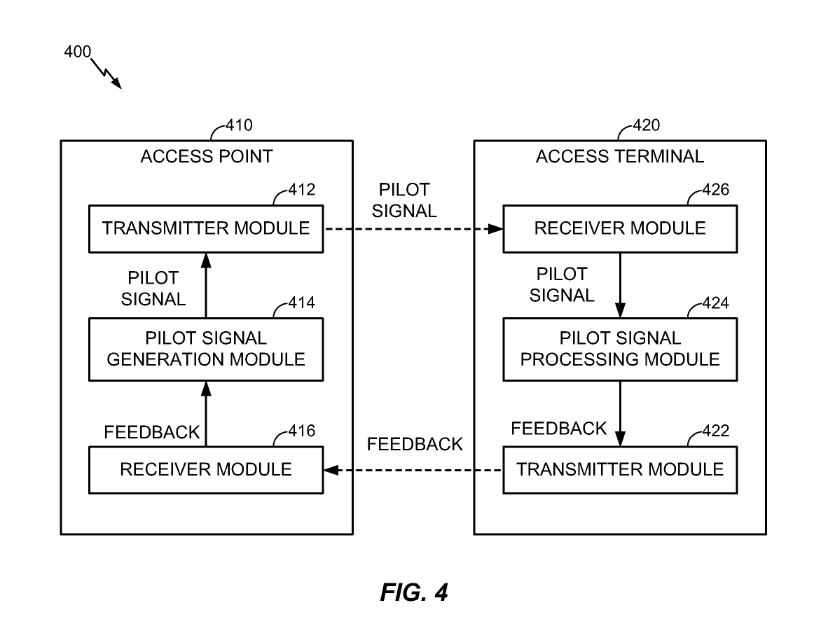

FIG. 4 illustrates an example system 400 with an access point (AP) 410 and an access terminal (AT) 420, capable of performing the hybrid time and frequency domain CSI feedback scheme, as will be discussed further herein. As illustrated, the AP 410 may include a pilot signal generation module 414 for generating a pilot signal, wherein the pilot signal may be transmitted, via a transmitter module 412, to the AT 420. The AT 420 may process the pilot signal and provide feedback (e.g., CSI feedback) to the AP 410 (e.g., by performing the hybrid time and frequency domain CSI feedback scheme). The AT 420 may receive the pilot signal via a receiver module 426 and process the pilot signal via a pilot signal processing module 424. The feedback generated by the AT 420 may be transmitted via a transmitter module 422, and the AP 410 may receive the feedback via a receiver module 416. After receiving the feedback, the AP 410 may reconstruct the pilot signal based on the feedback.

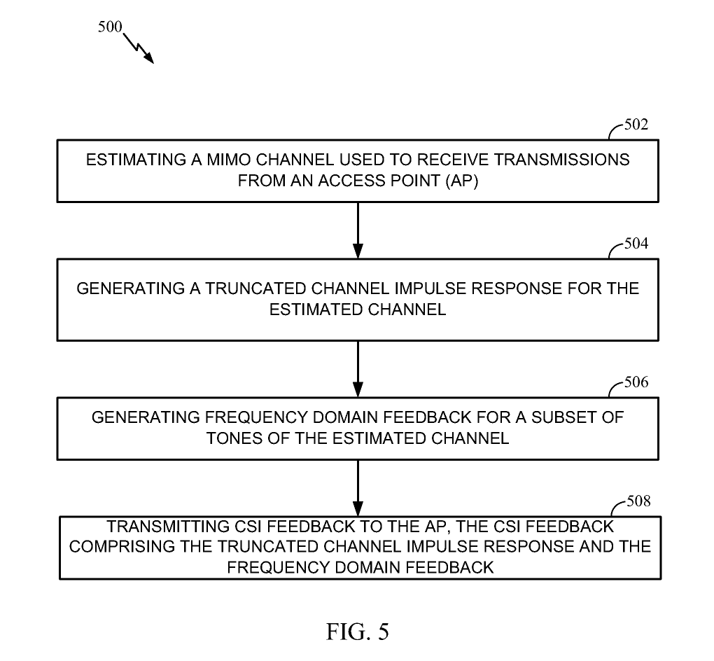

FIG. 5 illustrates example operations 500 that may be performed, for example, by an access terminal (AT), in accordance with certain aspects set forth herein. At 502, the AT may estimate a multiple input multiple output (MIMO) channel used to receive transmissions from an access point (AP). At 504, the AT may generate a truncated channel impulse response for the estimated channel. At 506, the AT may generate frequency domain feedback for a subset of tones of the estimated channel. At 508, the AT may transmit channel state information (CSI) feedback to the AP, the CSI feedback comprising the truncated channel impulse response and the frequency domain feedback.

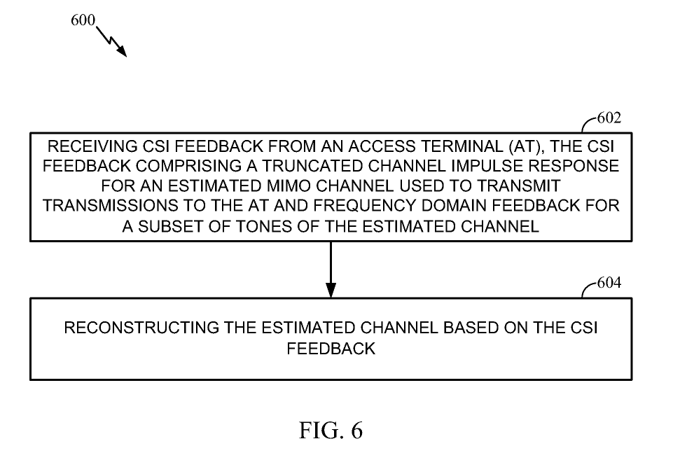

FIG. 6 illustrates example operations 600 that may be performed, for example, by an access point (AP), in accordance with certain aspects set forth herein. At 602, the AP may receive channel state information (CSI) feedback from an access terminal (AT), the CSI feedback comprising a truncated channel impulse response for an estimated multiple input multiple output (MIMO) channel used to transmit transmissions to the AT and frequency domain feedback for a subset of tones of the estimated channel. At 604, the AP may reconstruct the estimated channel based on the CSI feedback.

For some embodiments, a STA may do the following for transmitting a hybrid time and frequency domain CSI feedback scheme. First, the STA may window an estimated frequency domain channel, using rolloff subcarriers, wherein there may be a rolloff at the band edges and around direct current (DC). For example, for 40 MHz, there may be 16 rolloff subcarriers. Second, the STA may take the inverse fast Fourier transform (IFFT) of the windowed frequency domain channel to determine a channel impulse response. Third, the STA may truncate the channel impulse response to the CP length, quantize, and feedback to an access point (AP). For example, eight bits of I and eight bits of Q may give a mean squared error (MSE) of −38 dBc. For some embodiments, the STA may further feedback 3 bits scaling factor per tap (e.g., one scaling for all spatial elements). Fourth, on the band edge tones and around DC, the STA may send the quantized frequency domain channel coefficient values (e.g., eight bits of I and eight bits of Q for the frequency domain channel on the band edge tones and around DC).

For some embodiments, an access point (AP) may do the following for reconstructing the hybrid time and frequency domain CSI feedback scheme. First, the AP may take the fast Fourier transform (FFT) of the channel impulse response that was fed back from the STA. Second, the AP may multiply the product obtained from FFT operation with the inverse of the window used by the STA, and the AP may replace the band edge tones and the tones around DC with frequency domain values received from the STA.

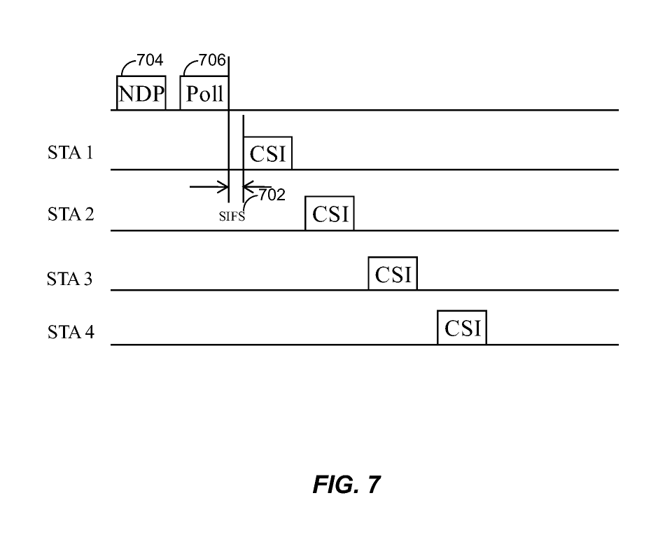

FIG. 7 illustrates a sequential CSI feedback scheme in accordance with certain aspects of the present disclosure. For some embodiments, the impulse response calculation of the hybrid scheme may need Ntx times Nss IFFT operations, wherein Ntx is the number of transmit antennas and Nss is the number of spatial streams. For example, for an eight Tx AP sending two ss each to four STAs at a time, sixteen IFFTs may need to be finished within the short inter-frame space (SIFS) 702 after the first poll message 706. Processing may happen during the NDP 704 and poll 706 as well. Typical per symbol FFT may take, for example, about 1 ms. FFT may be idle for a large fraction of the time. The impulse response calculation may seem achievable with existing FFT hardware.

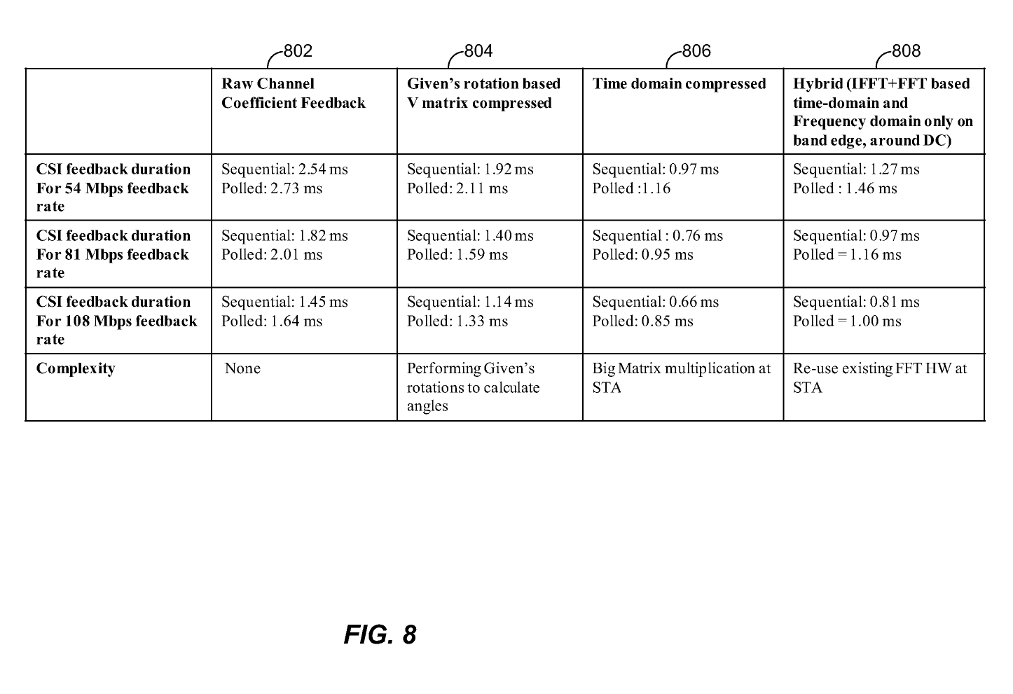

FIG. 8 illustrates a table of performance specifications comparing the CSI feedback duration for various options for an eight Tx AP sending two ss each to four STAs at a time. For example, for 40 MHz, at a 54 Mbps feedback rate, uncompressed CSI feedback 802 from four clients may take about 2.54 ms. Given's rotation based compressed CSI feedback 804 from four clients may take about 1.92 ms. Time domain based compressed CSI feedback 806 (i.e., assuming 4× compression) may take about 0.97 ms. Hybrid feedback 808 (e.g., time domain plus frequency domain on the band edge and around DC) may take about 1.27 ms. Performance specifications for the hybrid feedback 808 illustrate significant compression gains while keeping the STA complexity to a minimum.

However, gain from CSI compression may depend on the CSI feedback rate. If CSI feedback needs to happen before every MU-MIMO transmission, the overhead reduction may be significant. For example, assuming a MU-MIMO transmission every 5 ms, uncompressed feedback 802 may occupy 50% of the airtime, compressed V matrix feedback 804 may occupy 37% of the airtime, time domain compressed feedback 806 may occupy 19% of the airtime, and hybrid feedback 808 may occupy 25% of the airtime.

For some embodiments, a unified feedback format at the STA (i.e., single feedback method) may reduce the above-mentioned complexity while maintaining significant compression gains. The unified feedback format at the STA may involve the STA reporting the frequency domain channel on every two, three, or four tones, based on VHT-LTFs (very high throughput long training fields), and the STA further reporting frequency domain feedback for some of the tones, as will be described further.

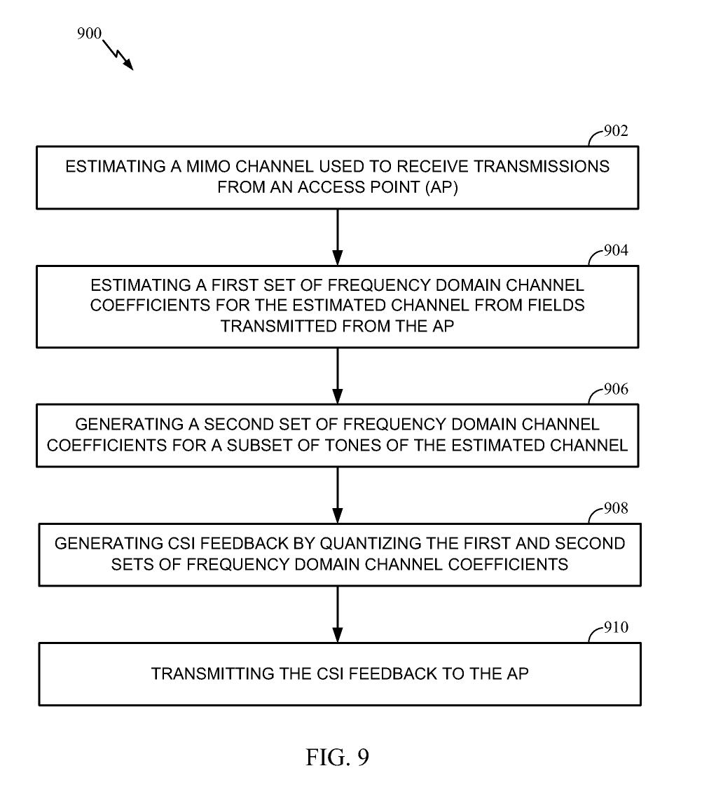

FIG. 9 illustrates example operations 900 that may be performed, for example, by an access terminal (AT), in accordance with certain aspects set forth herein. At 902, the AT may estimate a multiple input multiple output (MIMO) channel used to receive transmissions from an access point (AP). At 904, the AT may estimate a first set of frequency domain channel coefficients for the estimated channel from fields (e.g., very high throughput long training fields (VHT-LTFs)) transmitted from the AP. For some embodiments, the AT may directly record the frequency domain channel coefficients from the VHT-LTFs (e.g., from evenly spaced frequency domain tones and tones adjacent to guard tones and direct current (DC) tones).

At 906, the AT may generate a second set of frequency domain channel coefficients for a subset of tones of the estimated channel. At 908, the AT may generate channel state information (CSI) feedback by quantizing the first and second sets of frequency domain channel coefficients. For some embodiments, the AT may include additional receiver information, for example, coefficients used in a windowing function. At 910, the AT may transmit the CSI feedback to the AP.

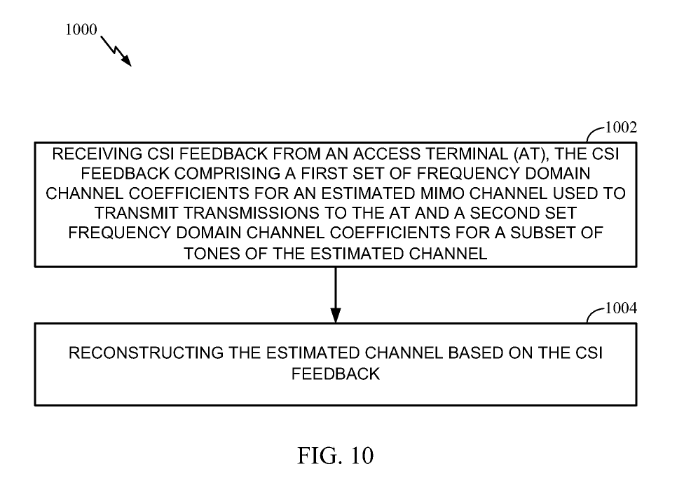

FIG. 10 illustrates example operations 1000 that may be performed, for example, by an access point (AP), in accordance with certain aspects set forth herein. At 1002, the AP may receive channel state information (CSI) feedback from an access terminal (AT), the CSI feedback comprising a first set of frequency domain channel coefficients for an estimated multiple input multiple output (MIMO) channel used to transmit transmissions to the AT and a second set frequency domain channel coefficients for a subset of tones of the estimated channel. At 1004, the AP may reconstruct the estimated channel based on the CSI feedback.

For some embodiments, a STA may do the following for transmitting a unified feedback format CSI feedback scheme. First, the STA may window the estimated frequency domain channel, using a window function that has a smooth rolloff at the band edge and DC subcarriers. For example, in 40 MHz, there may be a sixteen tone rolloff at the band edges and around DC. Second, the STA may take an N_{fft} point IFFT to obtain the time-domain channel impulse response, where N_{fft} is the total number of tones (e.g., N_{fft}=128 for a 40 MHz band). Third, the STA may truncate the time-domain channel impulse response to CP length. Fourth, the STA may take an N point FFT of the truncated time-domain channel impulse response to get to the effective frequency domain channel coefficients for every (N_{fft}/N) fraction of the tones. For some embodiments, N may be N_{fft}/2 or N_{fft}/4 (i.e., less than N_{fft}). Fifth, the STA may quantize the reduced number of frequency domain channel coefficients with an 8-bit I and 8-bit Q resolution. Further, the STA may quantize and send a few tones at band edge and around DC of the original frequency domain channel coefficients (e.g., a total of sixteen tones for 40 MHz). In addition, the STA may transmit additional receiver information comprising a receiver decoder type comprising a maximum likelihood (ML) decoder and a minimum mean square error (MMSE) decoder.

For some embodiments, an access point (AP) may do the following for reconstructing the unified feedback format CSI feedback scheme. First, the AP may take an N point IFFT of the frequency domain channel coefficients fed back by the STA to obtain an N-length time-domain impulse response. Second, the AP may truncate the resulting time-domain impulse response to CP length. Third, the AP may take an N_{fft} point FFT of the truncated time-domain impulse response to obtain the reconstructed frequency domain channel coefficients. Fourth, the AP may multiply the output of the FFT in the previous step with the inverse of the window used by the STA to obtain the reconstructed frequency domain channel coefficients. Fifth, the AP may replace band edge tones and tones around the DC of the reconstructed frequency domain channel coefficients with the corresponding frequency domain values directly fed back from the STA.

For some embodiments, the STA may choose to implement an easier method for determining the values of the channel coefficients to be fed back, as will be further described. However, the above-described method (i.e., more difficult method) may provide greater client performance in MU-MIMO. First, the STA may sub-sample the frequency domain channel coefficients from the VHT-LTFs by a factor of two, three, or four. Second, the STA may quantize the sub-sampled channel coefficients using an 8-bit 1 and 8-bit Q resolution. Third, the STA may feed back the quantized version of the sub-sampled frequency domain channel coefficients, and also a few additional tones (with 8-bit I/Q quantization) at band edge and around DC.

For some embodiments, an access point (AP) may do the following for reconstructing the unified feedback format CSI feedback scheme. First, the AP may take the sub-sampled frequency domain channel coefficients fed back from the STA and filter with a window function that has a smooth rolloff at band edge and DC tones. Second, the AP may take an N point IFFT of the above filtered frequency domain channel coefficients to obtain an N-length time-domain impulse response, where N is the number of sub-sampled frequency domain channel coefficients fed back by the STA. Third, the AP may truncate the resulting N-length time-domain impulse response to CP length. Fourth, the AP may take an N_{fft} point FFT of the truncated time-domain impulse response to obtain the reconstructed frequency domain channel coefficients. Fifth, the AP may multiply the output of the FFT in the previous step with the inverse of the window in the first step to obtain the reconstructed frequency domain channel coefficients. Sixth, the AP may replace band edge tones and tones around DC of the reconstructed frequency domain channel coefficients with the corresponding frequency domain values directly fed back from the STA. Further, the AP may compute precoder matrices using the quantized values of the first and second sets of frequency domain channel coefficients and linearly interpolate the precoder matrices.

The unified feedback format CSI feedback scheme may provide attractive overhead reduction when the number of STAs becomes large. Advantages of utilizing the CSI compression may depend on how often the CSI is requested. When there are requests for CSI before every MU-MIMO transmission, the overhead reduction may be a substantial amount. Time domain representation may be essential to maintain DL MU-MIMO benefits in networks with a large number of STAs. However, the unified feedback format described above may provide significant compression gains while keeping the STA complexity to a minimum.

The various operations of methods described above may be performed by any suitable means capable of performing the corresponding functions. The means may include various hardware and/or software component(s) and/or module(s), including, but not limited to a circuit, an application specific integrated circuit (ASIC), or processor. As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

1. A method for wireless transmissions, comprising:
estimating a multiple input multiple output (MIMO) channel used to receive transmissions from an access point (AP);
generating a truncated channel impulse response for the estimated channel;
generating frequency domain feedback for a subset of tones of the estimated channel; and
transmitting channel state information (CSI) feedback to the AP, the CSI feedback comprising the truncated channel impulse response and the frequency domain feedback.

2. The method of claim 1, wherein the subset of tones comprises at least one of band edge tones and direct current (DC) tones.

3. The method of claim 1, wherein generating the truncated channel impulse response comprises:
windowing the estimated MIMO channel using the subset of tones;
taking an Inverse Fast Fourier Transform (IFFT) of the windowed MIMO channel to generate a channel impulse response; and
truncating the channel impulse response to a cyclic prefix (CP) length to generate the truncated channel impulse response.

4. The method of claim 1, wherein transmitting comprises:
quantizing the truncated channel impulse response and the frequency domain feedback; and
transmitting three bits of a scaling factor per tap.

5. An apparatus for wireless communications, comprising:
logic for estimating a multiple input multiple output (MIMO) channel used to receive transmissions from an access point (AP);
logic for generating a truncated channel impulse response for the estimated channel;
logic for generating frequency domain feedback for a subset of tones of the estimated channel; and
logic for transmitting channel state information (CSI) feedback to the AP, the CSI feedback comprising the truncated channel impulse response and the frequency domain feedback.

6. The apparatus of claim 5, wherein the subset of tones comprises at least one of band edge tones and direct current (DC) tones.

7. The apparatus of claim 5, wherein the logic for generating the truncated channel impulse response comprises:
logic for windowing the estimated MIMO channel using the subset of tones;
logic for taking an Inverse Fast Fourier Transform (IFFT) of the windowed MIMO channel to generate a channel impulse response; and
logic for truncating the channel impulse response to a cyclic prefix (CP) length to generate the truncated channel impulse response.

8. The apparatus of claim 5, wherein the logic for transmitting comprises:
logic for quantizing the truncated channel impulse response and the frequency domain feedback; and
logic for transmitting three bits of a scaling factor per tap.

9. An apparatus for wireless communications, comprising:
means for estimating a multiple input multiple output (MIMO) channel used to receive transmissions from an access point (AP);
means for generating a truncated channel impulse response for the estimated channel;
means for generating frequency domain feedback for a subset of tones of the estimated channel; and
means for transmitting channel state information (CSI) feedback to the AP, the CSI feedback comprising the truncated channel impulse response and the frequency domain feedback.

10. A computer-program product for wireless communications, comprising a computer readable medium having instructions stored thereon, the instructions being executable by one or more processors and the instructions comprising:
instructions for estimating a multiple input multiple output (MIMO) channel used to receive transmissions from an access point (AP);
instructions for generating a truncated channel impulse response for the estimated channel;
instructions for generating frequency domain feedback for a subset of tones of the estimated channel; and
instructions for transmitting channel state information (CSI) feedback to the AP, the CSI feedback comprising the truncated channel impulse response and the frequency domain feedback.

11. A method for wireless communications, comprising:
receiving channel state information (CSI) feedback from an access terminal (AT), the CSI feedback comprising a truncated channel impulse response for an estimated multiple input multiple output (MIMO) channel used to transmit transmissions to the AT and frequency domain feedback for a subset of tones of the estimated channel; and
reconstructing the estimated channel based on the CSI feedback.

12. The method of claim 11, wherein the subset of tones comprise at least one of band edge tones and direct current (DC) tones.

13. The method of claim 11, wherein reconstructing the estimated MIMO channel comprises:
taking a Fast Fourier Transform (FFT) of the truncated channel impulse response;
multiplying the FFT of the truncated channel impulse response with an inverse of a windowing function used at the AT to generate the truncated channel impulse response; and
replacing the subset of tones of the estimated channel with values from the frequency domain feedback.

14. An apparatus for wireless communications, comprising:
logic for receiving channel state information (CSI) feedback from an access terminal (AT), the CSI feedback comprising a truncated channel impulse response for an estimated multiple input multiple output (MIMO) channel used to transmit transmissions to the AT and frequency domain feedback for a subset of tones of the estimated channel; and
logic for reconstructing the estimated channel based on the CSI feedback.

15. The apparatus of claim 14, wherein the subset of tones comprise at least one of band edge tones and direct current (DC) tones.

16. The apparatus of claim 14, wherein the logic for reconstructing the estimated MIMO channel comprises:
logic for taking a Fast Fourier Transform (FFT) of the truncated channel impulse response;
logic for multiplying the FFT of the truncated channel impulse response with an inverse of a windowing function used at the AT to generate the truncated channel impulse response; and
logic for replacing the subset of tones of the estimated channel with values from the frequency domain feedback.

17. An apparatus for wireless communications, comprising:
means for receiving channel state information (CSI) feedback from an access terminal (AT), the CSI feedback comprising a truncated channel impulse response for an estimated multiple input multiple output (MIMO) channel used to transmit transmissions to the AT and frequency domain feedback for a subset of tones of the estimated channel; and
means for reconstructing the estimated channel based on the CSI feedback.

18. A computer-program product for wireless communications, comprising a computer readable medium having instructions stored thereon, the instructions being executable by one or more processors and the instructions comprising:
instructions for receiving channel state information (CSI) feedback from an access terminal (AT), the CSI feedback comprising a truncated channel impulse response for an estimated multiple input multiple output (MIMO) channel used to transmit transmissions to the AT and frequency domain feedback for a subset of tones of the estimated channel; and
instructions for reconstructing the estimated channel based on the CSI feedback.

19. A method for transmitting channel state information (CSI) feedback in 802.11 wireless communications, comprising:
estimating a first set of frequency domain channel coefficients from very high throughput long training fields (VHT-LTFs) transmitted from an access point (AP);
generating a second set of frequency domain channel coefficients for a subset of tones;
generating the CSI feedback by quantizing the first and second sets of frequency domain channel coefficients and including additional receiver information; and
transmitting the CSI feedback to the AP.

20. The method of claim 19, wherein estimating the first set of frequency domain channel coefficients comprises:
generating a truncated channel impulse response; and
taking a Fast Fourier Transform (FFT) of the truncated channel impulse response to estimate the first set of frequency domain channel coefficients.

21. The method of claim 19, wherein estimating the first set of frequency domain channel coefficients comprises:
directly recording frequency domain channel coefficients from the VHT-LTFs.

22. The method of claim 19, wherein the additional receiver information comprises a receiver decoder type comprising a maximum likelihood (ML) decoder and a minimum mean square error (MMSE) decoder.

23. The method of claim 20, wherein generating the truncated channel impulse response comprises:
windowing frequency domain channel coefficients computed from the VHT-LTFs;
taking an Inverse Fast Fourier Transform (IFFT) of the frequency domain channel coefficients using a first number of points to generate a channel impulse response; and
truncating the channel impulse response to a cyclic prefix (CP) length to generate the truncated channel impulse response.

24. The method of claim 23, wherein the additional receiver information comprises coefficients used in the windowing function.

25. The method of claim 23, wherein taking the FFT of the truncated channel impulse response comprises taking the FFT using a second number of points that is less than the first number of points.

26. The method of claim 21, wherein directly recording the frequency domain channel coefficients comprises:
directly recording from evenly spaced frequency domain tones and tones adjacent to guard tones and direct current (DC) tones.

27. The method of claim 26, wherein the evenly spaced tones comprises tones spaced by two, three, or four tones.

28. The method of claim 19, wherein quantizing the first and second sets of frequency domain channel coefficients comprises:
generating three bits of a scaling factor per channel tap.

29. The method of claim 19, wherein the subset of tones comprises at least one of band edge tones and direct current (DC) tones.

30. An apparatus for transmitting channel state information (CSI) feedback in 802.11 wireless communications, comprising:
logic for estimating a first set of frequency domain channel coefficients from very high throughput long training fields (VHT-LTFs) transmitted from an access point (AP);
logic for generating a second set of frequency domain channel coefficients for a subset of tones;
logic for generating the CSI feedback by quantizing the first and second sets of frequency domain channel coefficients and including additional receiver information; and
logic for transmitting the CSI feedback to the AP.

31. The apparatus of claim 30, wherein the logic for estimating the first set of frequency domain channel coefficients comprises:
logic for generating a truncated channel impulse response; and
logic for taking a Fast Fourier Transform (FFT) of the truncated channel impulse response to estimate the first set of frequency domain channel coefficients.

32. The apparatus of claim 30, wherein the logic for estimating the first set of frequency domain channel coefficients comprises:
logic for directly recording frequency domain channel coefficients from the VHT-LTFs.

33. The apparatus of claim 30, wherein the additional receiver information comprises a receiver decoder type comprising a maximum likelihood (ML) decoder and a minimum mean square error (MMSE) decoder.

34. The apparatus of claim 31, wherein the logic for generating the truncated channel impulse response comprises:
logic for windowing frequency domain channel coefficients computed from the VHT-LTFs;
logic for taking an Inverse Fast Fourier Transform (IFFT) of the frequency domain channel coefficients using a first number of points to generate a channel impulse response; and
logic for truncating the channel impulse response to a cyclic prefix (CP) length to generate the truncated channel impulse response.

35. The apparatus of claim 34, wherein the additional receiver information comprises coefficients used in the windowing function.

36. The apparatus of claim 34, wherein the logic for taking the FFT of the truncated channel impulse response comprises logic for taking the FFT using a second number of points that is less than the first number of points.

37. The apparatus of claim 32, wherein the logic for directly recording the frequency domain channel coefficients comprises:
logic for directly recording from evenly spaced frequency domain tones and tones adjacent to guard tones and direct current (DC) tones.

38. The apparatus of claim 37, wherein the evenly spaced tones comprises tones spaced by two, three, or four tones.

39. The apparatus of claim 30, wherein the logic for quantizing the first and second sets of frequency domain channel coefficients comprises:
logic for generating three bits of a scaling factor per channel tap.

40. The apparatus of claim 30, wherein the subset of tones comprises at least one of band edge tones and direct current (DC) tones.

41. An apparatus for transmitting channel state information (CSI) feedback in 802.11 wireless communications, comprising:
means for estimating a first set of frequency domain channel coefficients from very high throughput long training fields (VHT-LTFs) transmitted from an access point (AP);
means for generating a second set of frequency domain channel coefficients for a subset of tones;
means for generating the CSI feedback by quantizing the first and second sets of frequency domain channel coefficients and including additional receiver information; and
means for transmitting the CSI feedback to the AP.

42. A computer-program product for transmitting channel state information (CSI) feedback in 802.11 wireless communications, comprising a computer readable medium having instructions stored thereon, the instructions being executable by one or more processors and the instructions comprising:
instructions for estimating a first set of frequency domain channel coefficients from very high throughput long training fields (VHT-LTFs) transmitted from an access point (AP);
instructions for generating a second set of frequency domain channel coefficients for a subset of tones;
instructions for generating the CSI feedback by quantizing the first and second sets of frequency domain channel coefficients and including additional receiver information; and
instructions for transmitting the CSI feedback to the AP.

43. A method for wireless communications, comprising:
estimating a multiple input multiple output (MIMO) channel used to receive transmissions from an access point (AP);
estimating a first set of frequency domain channel coefficients for the estimated channel from fields transmitted from the AP;
generating a second set of frequency domain channel coefficients for a subset of tones of the estimated channel;
generating channel state information (CSI) feedback by quantizing the first and second sets of frequency domain channel coefficients; and
transmitting the CSI feedback to the AP.

44. The method of claim 43, wherein the fields transmitted from the AP comprise very high throughput long training fields (VHT-LTFs).

45. The method of claim 43, wherein generating the CSI feedback comprises including receiver information.

46. The method of claim 45, wherein the receiver information comprises:
a receiver decoder type comprising a maximum likelihood (ML) decoder and a minimum mean square error (MMSE) decoder; and
window coefficients used to generate the quantized values of the first set of frequency domain channel coefficients.

47. An apparatus for wireless communications, comprising:
logic for estimating a multiple input multiple output (MIMO) channel used to receive transmissions from an access point (AP);
logic for estimating a first set of frequency domain channel coefficients for the estimated channel from fields transmitted from the AP;
logic for generating a second set of frequency domain channel coefficients for a subset of tones of the estimated channel;
logic for generating channel state information (CSI) feedback by quantizing the first and second sets of frequency domain channel coefficients; and
logic for transmitting the CSI feedback to the AP.

48. The apparatus of claim 47, wherein the fields transmitted from the AP comprise very high throughput long training fields (VHT-LTFs).

49. The apparatus of claim 47, wherein the logic for generating the CSI feedback comprises logic for including receiver information.

50. The apparatus of claim 49, wherein the receiver information comprises:
a receiver decoder type comprising a maximum likelihood (ML) decoder and a minimum mean square error (MMSE) decoder; and
window coefficients used to generate the quantized values of the first set of frequency domain channel coefficients.

51. An apparatus for wireless communications, comprising:
means for estimating a multiple input multiple output (MIMO) channel used to receive transmissions from an access point (AP);
means for estimating a first set of frequency domain channel coefficients for the estimated channel from fields transmitted from the AP;
means for generating a second set of frequency domain channel coefficients for a subset of tones of the estimated channel;
means for generating channel state information (CSI) feedback by quantizing the first and second sets of frequency domain channel coefficients; and
means for transmitting the CSI feedback to the AP.

52. A computer-program product for wireless communications, comprising a computer readable medium having instructions stored thereon, the instructions being executable by one or more processors and the instructions comprising:
instructions for estimating a multiple input multiple output (MIMO) channel used to receive transmissions from an access point (AP);
instructions for estimating a first set of frequency domain channel coefficients for the estimated channel from fields transmitted from the AP;
instructions for generating a second set of frequency domain channel coefficients for a subset of tones of the estimated channel;
instructions for generating channel state information (CSI) feedback by quantizing the first and second sets of frequency domain channel coefficients; and
instructions for transmitting the CSI feedback to the AP.

53. A method for wireless communications, comprising:
receiving channel state information (CSI) feedback from an access terminal (AT), the CSI feedback comprising:
receiver information;
quantized values of a first set of frequency domain channel coefficients from very high throughput long training fields (VHT-LTFs) used to transmit transmissions to the AT; and
quantized values of a second set of frequency domain channel coefficients for a subset of tones; and
reconstructing an estimated multiple input multiple output (MIMO) channel based on the CSI feedback.

54. The method of claim 53, wherein the subset of tones comprise at least one of band edge tones and direct current (DC) tones.

55. The method of claim 53, wherein the receiver information comprises:
a receiver decoder type comprising a maximum likelihood (ML) decoder and a minimum mean square error (MMSE) decoder; and
window coefficients used to generate the quantized values of the first set of frequency domain channel coefficients.

56. The method of claim 53, wherein reconstructing the estimated MIMO channel comprises:
taking an Inverse Fast Fourier Transform (IFFT) of the quantized values of the first set of frequency domain channel coefficients using a first number of points to generate a channel impulse response;
truncating the channel impulse response to a cyclic prefix (CP) length to generate the truncated channel impulse response;
taking a Fast Fourier Transform (FFT) of the truncated channel impulse response using a second number of points that is greater than the first number of points;
multiplying the FFT of the truncated channel impulse response with an inverse of a windowing function used at the AT to generate the truncated channel impulse response; and
replacing the subset of tones of the estimated channel with values from the quantized values of the second set of frequency domain channel coefficients.

57. The method of claim 53, wherein reconstructing the estimated MIMO channel comprises:
linearly interpolating the quantized values of the first set of frequency domain channel coefficients; and
replacing the subset of tones of the estimated channel with values from the quantized values of the second set of frequency domain channel coefficients.

58. The method of claim 53, further comprising:
computing precoder matrices using the quantized values of the first and second sets of frequency domain channel coefficients; and
linearly interpolating the precoder matrices.

59. An apparatus for wireless communications, comprising:
logic for receiving channel state information (CSI) feedback from an access terminal (AT), the CSI feedback comprising:
receiver information;
quantized values of a first set of frequency domain channel coefficients from very high throughput long training fields (VHT-LTFs) used to transmit transmissions to the AT; and
quantized values of a second set of frequency domain channel coefficients for a subset of tones; and
logic for reconstructing an estimated multiple input multiple output (MIMO) channel based on the CSI feedback.

60. The apparatus of claim 59, wherein the subset of tones comprise at least one of band edge tones and direct current (DC) tones.

61. The apparatus of claim 59, wherein the receiver information comprises:
a receiver decoder type comprising a maximum likelihood (ML) decoder and a minimum mean square error (MMSE) decoder; and
window coefficients used to generate the quantized values of the first set of frequency domain channel coefficients.

62. The apparatus of claim 59, wherein the logic for reconstructing the estimated MIMO channel comprises:
logic for taking an Inverse Fast Fourier Transform (IFFT) of the quantized values of the first set of frequency domain channel coefficients using a first number of points to generate a channel impulse response;
logic for truncating the channel impulse response to a cyclic prefix (CP) length to generate the truncated channel impulse response;
logic for taking a Fast Fourier Transform (FFT) of the truncated channel impulse response using a second number of points that is greater than the first number of points;
logic for multiplying the FFT of the truncated channel impulse response with an inverse of a windowing function used at the AT to generate the truncated channel impulse response; and
logic for replacing the subset of tones of the estimated channel with values from the quantized values of the second set of frequency domain channel coefficients.

63. The apparatus of claim 59, wherein the logic for reconstructing the estimated MIMO channel comprises:
logic for linearly interpolating the quantized values of the first set of frequency domain channel coefficients; and
logic for replacing the subset of tones of the estimated channel with values from the quantized values of the second set of frequency domain channel coefficients.

64. The apparatus of claim 59, further comprising:
logic for computing precoder matrices using the quantized values of the first and second sets of frequency domain channel coefficients; and
logic for linearly interpolating the precoder matrices.

65. An apparatus for wireless communications, comprising:
means for receiving channel state information (CSI) feedback from an access terminal (AT), the CSI feedback comprising:
receiver information;
quantized values of a first set of frequency domain channel coefficients from very high throughput long training fields (VHT-LTFs) used to transmit transmissions to the AT; and
quantized values of a second set of frequency domain channel coefficients for a subset of tones; and
means for reconstructing an estimated multiple input multiple output (MIMO) channel based on the CSI feedback.

66. A computer-program product for wireless communications, comprising a computer readable medium having instructions stored thereon, the instructions being executable by one or more processors and the instructions comprising:
instructions for receiving channel state information (CSI) feedback from an access terminal (AT), the CSI feedback comprising:
receiver information;
quantized values of a first set of frequency domain channel coefficients from very high throughput long training fields (VHT-LTFs) used to transmit transmissions to the AT; and
quantized values of a second set of frequency domain channel coefficients for a subset of tones; and
instructions for reconstructing an estimated multiple input multiple output (MIMO) channel based on the CSI feedback.

67. A method for wireless communications, comprising:
receiving channel state information (CSI) feedback from an access terminal (AT), the CSI feedback comprising a first set of frequency domain channel coefficients for an estimated multiple input multiple output (MIMO) channel used to transmit transmissions to the AT and a second set frequency domain channel coefficients for a subset of tones of the estimated channel; and
reconstructing the estimated channel based on the CSI feedback.

68. An apparatus for wireless communications, comprising:
logic for receiving channel state information (CSI) feedback from an access terminal (AT), the CSI feedback comprising a first set of frequency domain channel coefficients for an estimated multiple input multiple output (MIMO) channel used to transmit transmissions to the AT and a second set frequency domain channel coefficients for a subset of tones of the estimated channel; and
logic for reconstructing the estimated channel based on the CSI feedback.

69. An apparatus for wireless communications, comprising:
means for receiving channel state information (CSI) feedback from an access terminal (AT), the CSI feedback comprising a first set of frequency domain channel coefficients for an estimated multiple input multiple output (MIMO) channel used to transmit transmissions to the AT and a second set frequency domain channel coefficients for a subset of tones of the estimated channel; and
means for reconstructing the estimated channel based on the CSI feedback.

70. A computer-program product for wireless communications, comprising a computer readable medium having instructions stored thereon, the instructions being executable by one or more processors and the instructions comprising:
instructions for receiving channel state information (CSI) feedback from an access terminal (AT), the CSI feedback comprising a first set of frequency domain channel coefficients for an estimated multiple input multiple output (MIMO) channel used to transmit transmissions to the AT and a second set frequency domain channel coefficients for a subset of tones of the estimated channel; and
instructions for reconstructing the estimated channel based on the CSI feedback.
